(19) United States
(12) Patent Application Publication
(10) Pub. No.: US 2014/0232704 A1
(43) Pub. Date: Aug. 21, 2014

(54) METHOD FOR SWITCHING SCREEN AND ELECTRONIC DEVICE THEREOF

(71) Applicant: Samsung Electronics Co., Ltd., Gyeonggi-do (KR)

(72) Inventors: Moon-Soo KIM, Seoul (KR); Seung-Eun Lee, Seoul (KR); Byoung-Uk Yoon, Gyeonggi-do (KR); Yong-Sang Yun, Gyeonggi-do (KR)

(73) Assignee: Samsung Electronics Co., Ltd., Gyeonggi-do (KR)

(21) Appl. No.: 14/185,277

(22) Filed: Feb. 20, 2014

(30) Foreign Application Priority Data
Feb. 20, 2013 (KR) 10-2013-0018121

(51) Int. Cl. G09G 3/36

(52) U.S. Cl. CPC G09G 3/3611
USPC 345/204

(57) ABSTRACT

A method and an apparatus for switching a screen in an electronic device that uses a transparent display are provided. In the method, a state where a front direction of the electronic device is reversed from a first direction to a second direction, and a back direction of the electronic device is reversed from the second direction to the first direction are detected. When a front side and a backside of the electronic device are reversed, a left/right reversed screen or an up/down reversed screen is displayed.

### PRIORITY

This application claims priority under 35 U.S.C. §119(a) to a Korean Patent Application filed in the Korean Intellectual Property Office on Feb. 20, 2013 and assigned Serial No. 10-2013-0018121, the entire disclosure of which is incorporated herein by reference.

### BACKGROUND OF THE INVENTION

1. Field of the Invention

The present invention generally relates to a method for switching a screen and an electronic device thereof.

2. Description of the Related Art

Recently, a transparent display device has been actively under development and is being applied to various electronic devices. A transparent display device is a display in which an opposite side is viewable like a glass window when needed using a transparent electronic device. The transparent display device is based on Active Matrix Organic Light Emitting Diode (AMOLED) technology and utilizes a transparent oxide semiconductor and a transparent electrode, instead of a conventional opaque silicon and metal.

A transparent display has an advantage that not only another background on the opposite side of the display is able to be viewed but also the display may be used in both directions.

However, when a portable terminal with a conventional transparent display is turned over, that is, the viewing side of the front side and the backside of the portable terminal are reversed, an output screen of the front side is displayed via the transparent display, so that the output screen of the front side is viewed from behind with left and right sides of the screen being flipped.

Therefore, a method and an apparatus for preventing an output screen of a front side from being viewed with its left and right sides on a backside being reversed when directions of the front side and the backside of a portable terminal having a transparent display are reversed are required.

### SUMMARY OF THE INVENTION

An aspect of the present invention is to address at least the above-mentioned problems and/or disadvantages and to provide at least the advantages described below.

Accordingly, an aspect of the present invention is to provide a method and an apparatus for switching a screen in an electronic device that uses a transparent display.

Another aspect of the present invention is to provide a method and an apparatus for preventing an output screen of a front side from being viewed with its left and right sides on a backside being reversed when the portable terminal is turned over and directions of the front side and the backside of a portable terminal having a transparent display are reversed.

Still another aspect of the present invention is to provide a method and an apparatus for reversing left and right sides of a screen and displaying the same when detecting that the portable terminal has been turned over and a front side and a backside in a portable terminal having a transparent display has been reversed.

In accordance with an aspect of the present invention, a method for switching a screen of an electronic device that uses a transparent display is provided. The method includes detecting a state where a front direction of the electronic device is reversed from a first direction to a second direction, and a back direction of the electronic device is reversed from the second direction to the first direction, and when a front side and a backside of the electronic device are reversed, displaying a left/right reversed screen or an up/down reversed screen.

In accordance with another aspect of the present invention, an electronic device is provided. The electronic device includes one or more processors, a memory, and one or more programs stored in the memory and configured for execution by the one or more processors, wherein the program includes instructions for detecting a state where a front direction of the electronic device is reversed from a first direction to a second direction, and a back direction of the electronic device is reversed from the second direction to the first direction, and when a front side and a backside of the electronic device are reversed, displaying a left/right reversed screen or an up/down reversed screen.

In accordance with still another aspect of the present invention, a method for switching a screen of an electronic device that uses a transparent display is provided. The method includes detecting a user's face from images obtained via at least one of a first camera and a second camera of the electronic device, respectively, detecting a state where a front direction of the electronic device is reversed from a first direction to a second direction, and a back direction of the electronic device is reversed from the second direction to the first direction based on the face detection result, and when a front side and a backside of the electronic device are reversed, displaying a left/right reversed screen or an up/down reversed screen.

### BRIEF DESCRIPTION OF THE DRAWINGS

The above and other aspects, features and advantages of certain embodiments of the present invention will be more apparent from the following description taken in conjunction with the accompanying drawings in which:

FIGS. 1A and 1B illustrate a front side and a backside of an electronic device having a transparent display according to an embodiment of the present invention;

FIGS. 2A and 2B illustrate screens displayed via a front side and a backside of an electronic device having a transparent display according to an embodiment of the present invention;

FIGS. 3A and 3B illustrate a first scenario where directions of a front side and a backside of an electronic device having a transparent display are reversed according to an embodiment of the present invention;

FIG. 4 illustrates a first scenario where directions of a front side and a backside of an electronic device having a transparent display are reversed according to an embodiment of the present invention;

FIGS. 5A and 5B illustrate before and after screen switching when directions of a front side and a backside of an electronic device having a transparent display are reversed according to an embodiment of the present invention;

FIG. 6 is a flowchart illustrating a method for switching a screen of an electronic device according to an embodiment of the present invention;

FIGS. 7A, 7B and 7C illustrate before and after screen switching when directions of a front side and a backside of an electronic device having a transparent display are reversed, and the electronic device is changed from a horizontal direction to a vertical direction according to another embodiment of the present invention;

FIGS. 8A, 8B and 8C illustrate before and after screen switching when directions of a front side and a backside of an electronic device having a transparent display are reversed, and the electronic device is changed from a horizontal direction to a vertical direction according to still another embodiment of the present invention;

FIG. 9 is a flowchart illustrating a method for switching a screen of an electronic device according to an embodiment of the present invention; and

FIG. 10 is a block diagram illustrating an inner construction of an electronic device according to an embodiment of the present invention.

Throughout the drawings, like reference numerals will be understood to refer to like parts, components and structures.

### DETAILED DESCRIPTION OF EMBODIMENTS OF THE PRESENT INVENTION

The following description with reference to the accompanying drawings is provided to assist in a comprehensive understanding of embodiments of the present invention as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention are provided for illustration purposes only and not for the purpose of limiting the invention as defined by the appended claims and their equivalents.

Hereinafter, a method and an apparatus for determining a posture of an electronic device and performing screen switching in the electronic device that uses a transparent display, are described. Particularly, a method and an apparatus for determining a direction of a display in response to a posture of an electronic device after detecting the posture of the electronic device using a proximity sensor, a gyro sensor, or a camera, etc.

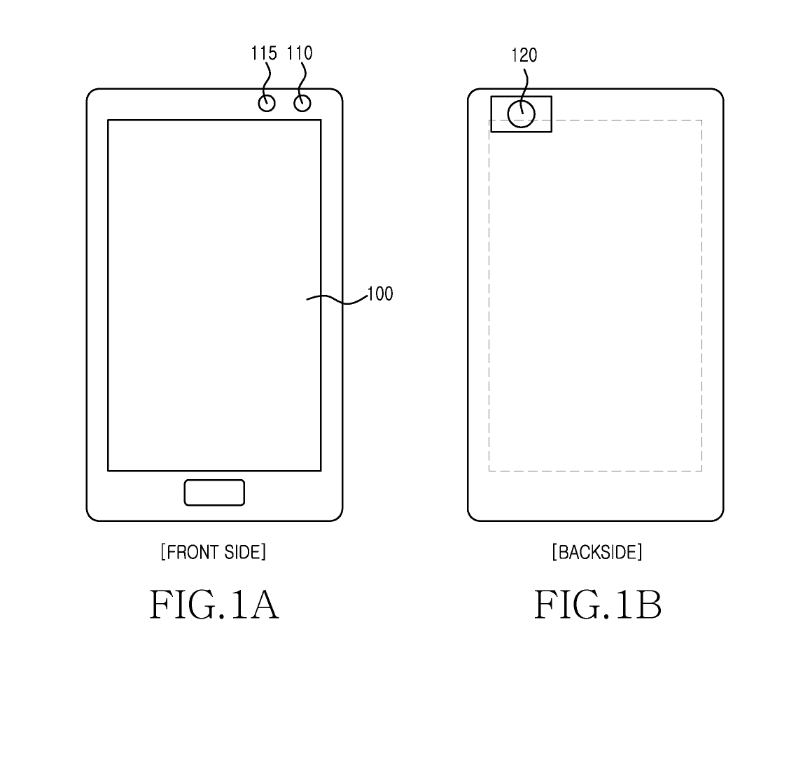

FIGS. 1A and 1B illustrate a front side and a backside of an electronic device having a transparent display according to an embodiment of the present invention.

FIG. 1A illustrates the front side of the electronic device. A sensor module 115, a first camera module 110, and a display unit 100 are formed on the front side of the electronic device. FIG. 1B illustrates the backside of the electronic device. A second camera module 120 is formed on the backside of the electronic device. The ‘front side’ and the ‘backside’ in the present invention as described herein are relative concepts, and according to an embodiment, FIG. 1A may denote the backside of the electronic device and FIG. 1B may denote the front side of the electronic device. Preferably, the sensor module 110 is a gyro sensor or an acceleration sensor.

The display unit 100 is a transparent display, and content displayed on the front side of the electronic device may be displayed on the backside of the electronic device for viewing from behind. Also, the display unit 100 is a two-sided display, and content displayed on the front side of the electronic device may be equally displayed on the backside of the electronic device. At this point, a display of the front side and a display of the backside may face each other.

The sensor module 115, the first camera module 110, or the second camera module 120 is used for determining the posture of the electronic device in the present invention. That is, they are used for determining the viewing side of the electronic device, such that the front side of the electronic device is facing the user and is referred to as “open”, and the backside is hidden, or the backside of the electronic device is facing the user and the front side is hidden.

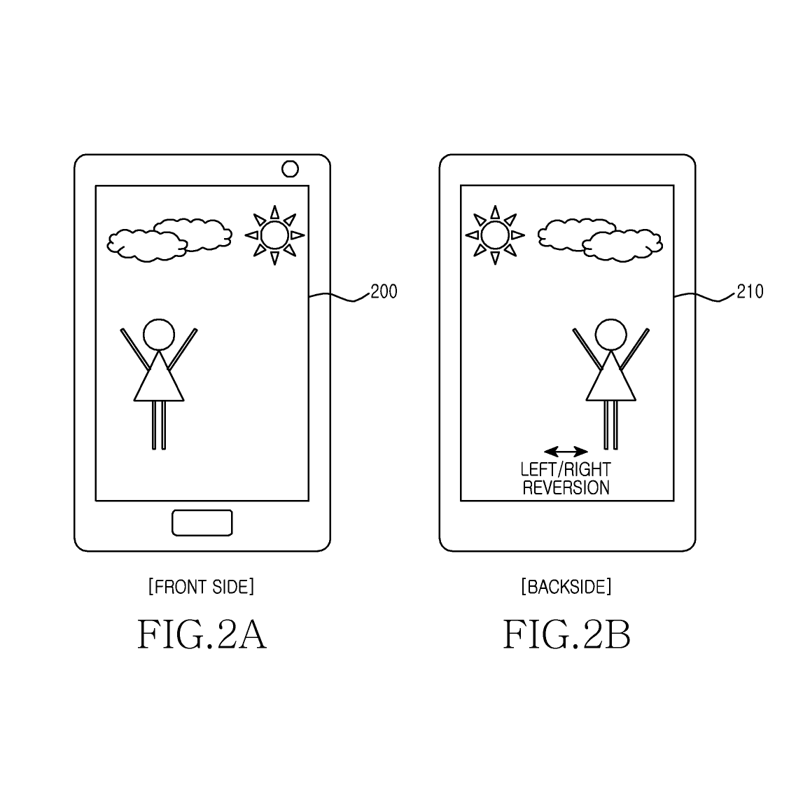

FIGS. 2A and 2B illustrate screens displayed via a front side and a backside of an electronic device having a transparent display according to an embodiment of the present invention.

FIG. 2A illustrates a screen 200 displayed on the front side of the electronic device, and a screen 210 displayed on the backside of the electronic device when the electronic device is turned over. At this point, the screen on the front side is projected and displayed as it is on the backside of the electronic device, and left and right sides of the screen are reversely displayed on the backside of the electronic device.

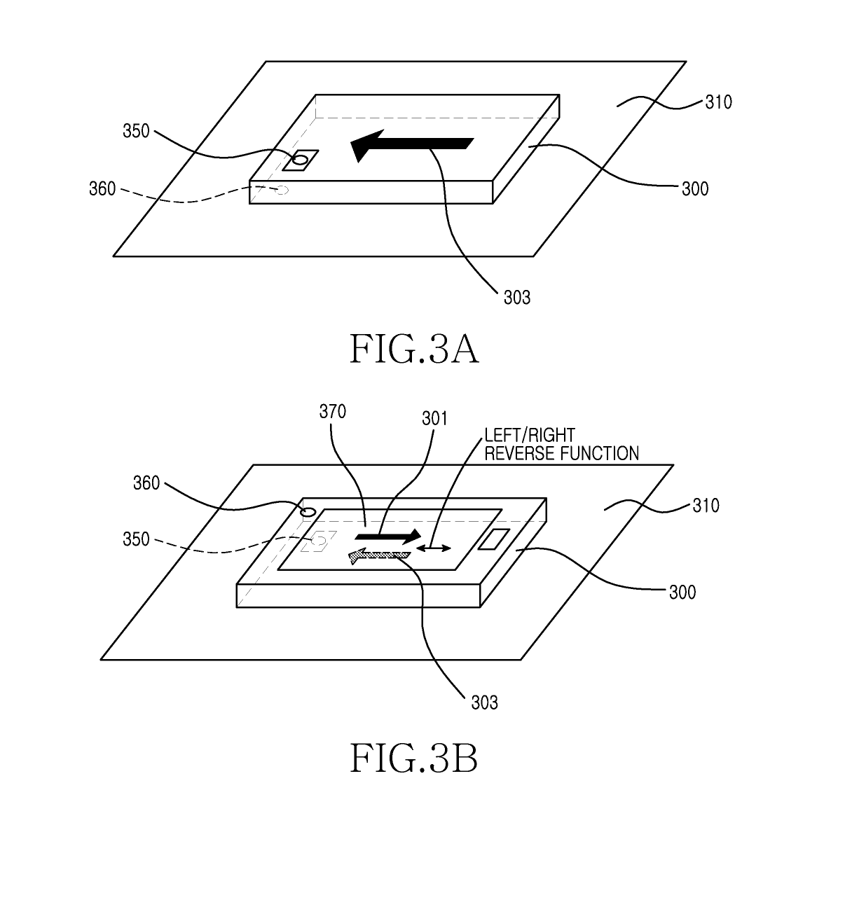

FIGS. 3A and 3B illustrate a first scenario where directions of a front side and a backside of an electronic device having a transparent display are reversed when the electronic device is turned over according to an embodiment of the present invention.

FIG. 3A illustrates an electronic device disposed with its backside facing the user and its front side hidden, and FIG. 3B illustrates an electronic device disposed with its front side facing the user and its backside hidden.

When a user puts an electronic device 300 on a plane 310 so that the backside faces the user in FIG. 3A and content (shown as a left arrow 303) of a display is displayed from behind in the back direction, and the electronic device 300 is turned over so that the front side faces the user in FIG. 3B, the front direction and the back direction are reversed, so that the left arrow 303 of FIG. 3B in the front direction will be displayed as a right arrow 301.

At this point, to prevent contents displayed on the front side and the backside of the electronic device from being displayed in an opposite direction when the electronic device is turned over, an embodiment of the present invention reverses the left and right sides of the screens to display the right facing arrow as a left facing arrow when the electronic device is turned over, that is, the front direction and the back direction of the electronic device are reversed.

Here, the electronic device may detect whether the electronic device approaches, acceleration, and angular velocity (or rotation speed) using a proximity sensor, an acceleration sensor, or a gyro sensor, and then determine whether the front side/backside is facing the user.

In another implementation, the electronic device may detect a user's face from an image obtained via camera modules 360 and 350 to determine the front side/backside of the electronic device. For example, when recognizing a user's face from an image obtained via a front camera, the electronic device may determine which side is the front side, and when recognizing the user's face from an image obtained via a backside camera, the electronic device may determine which side is the backside.

In still another implementation, the electronic device may determine whether the front side/backside is facing the user using an illuminance value measured by the front camera and the backside camera. For example, in FIG. 3B, since the front camera 360 is facing the user and the backside camera 350 is hidden by the plane, a second illuminance value measured by the backside camera 350 becomes relatively lower than a first illuminance value measured by the front camera 360. Therefore, the electronic device determines the electronic device is positioned with the front side of the electronic device facing the user and the backside hidden via comparison of illuminance values. In contrast, in FIG. 3A, in the electronic device positioned with its backside facing the user and its front side hidden, the backside camera 350 faces the user and the front side camera 360 is hidden by the plane 310, so that a first illuminance value measured by the front camera 360 has a relatively lower value than a second illuminance value measured by the backside camera 350. Therefore, the electronic device determines the electronic device is positioned with its backside facing the user and the front side hidden via comparison of the illuminance values.

Using the comparison result, when a difference between the first illuminance value and the second illuminance value is greater than or equal to a first threshold, it is determined that the electronic device is disposed with its backside open, and when the difference between the first illuminance value and the second illuminance value less than or equal to a second threshold, it is determined that the electronic device is disposed with its front side open.

Also, when the difference between the first illuminance value and the second illuminance value is a value between the first threshold and the second threshold, it is determined that the electronic device is disposed with both its front side and its backside open.

In another implementation, the electronic device may combine a sensor with a camera to determine whether the front side/backside of the electronic device is facing the user and front/back direction information of the electronic device.

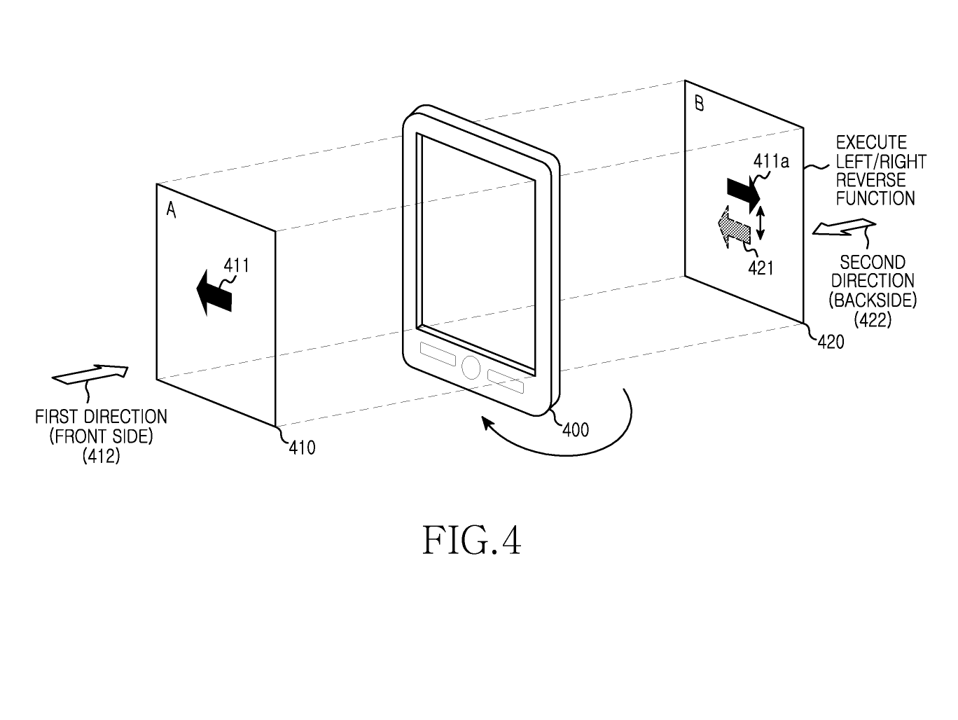

FIG. 4 illustrates a first scenario where directions of a front side and a backside of an electronic device having a transparent display are reversed according to an embodiment of the present invention.

Referring to FIG. 4, an electronic device 400 whose front side 410 and backside 420 are both open is illustrated. That is, FIG. 4 illustrates a circumstance where a user grips the electronic device 400 to view the screen from the front direction or the back direction.

While a user grips the electronic device 400 and views content (shown as a left arrow 411) of a display 410 in a front direction 412, when the electronic device 400 is turned over by the user so that it is rotated or reversed from front to back by the user, the front direction 412 of the display 410 and a back direction 422 of the display 420 are reversed, so that the left arrow 411 of the front direction 412 will be displayed as a right arrow 421 in the back direction 422.

At this point, to prevent contents displayed on the front side and the backside of the electronic device from being displayed in the reverse or opposite direction, when the electronic device is rotated and reversed, that is, the front direction and the back direction of the electronic device are reversed, an embodiment of the present invention reverses left/right screens to display the right arrow 421 as a left arrow 411a.

Here, the electronic device may detect whether the electronic device approaches, the acceleration and an angular velocity (or rotation speed) using a proximity sensor, an acceleration sensor, or a gyro sensor and then determine whether the front side/backside is open or faces the user and the front direction/back direction of the electronic device.

In another implementation, the electronic device may detect a user's face from an image obtained via camera modules 360 and 350 to determine the front side/backside of the electronic device. For example, when recognizing a user's face from an image obtained via a front camera, the electronic device may determine which side is the front side, and when recognizing the user's face from an image obtained via a backside camera, the electronic device may determine which side is the backside.

Depending on still another implementation, as described above the electronic device may determine whether the front side/backside is open and the front direction/back direction of the electronic device using an illuminance value measured by the front camera and the backside camera.

Alternatively, when both the front camera and the backside camera are open and facing the user, an illuminance value measured by a first camera and an illuminance value measured by a second camera may be the same or almost the same. Therefore, the electronic device determines the electronic device is positioned such that the front side and the backside are both open via comparison of the illuminance values.

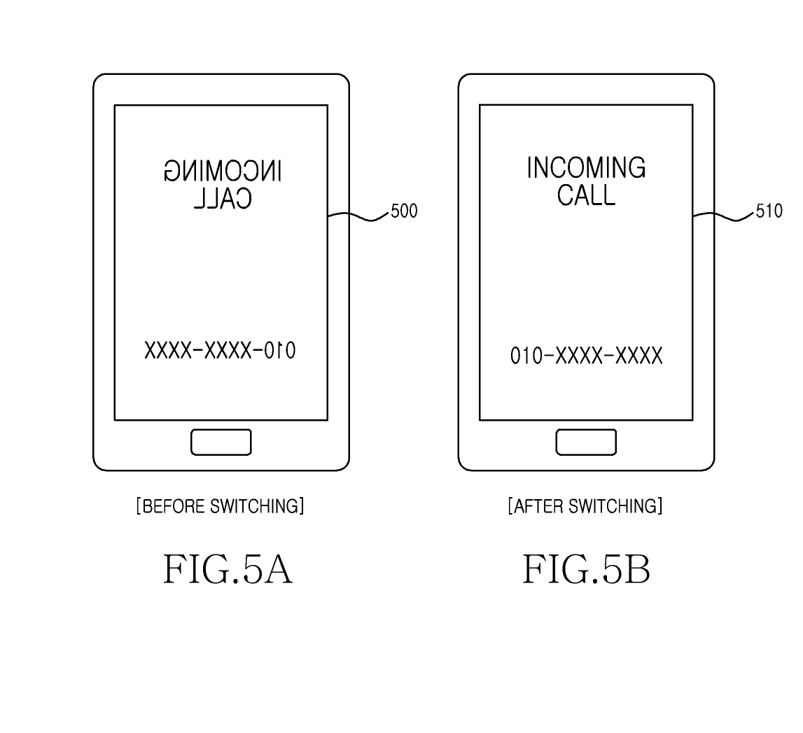

FIGS. 5A and 5B illustrate a display before and after screen switching views when directions of a front side and a backside of an electronic device having a transparent display are reversed according to an embodiment of the present invention.

FIG. 5A illustrates content on a display screen 500 displayed in the back direction before left/right screen switching when the electronic device has been turned over (rotated and reversed). That is, the front direction and the back direction of the electronic device have been reversed, while a call is received.

FIG. 5B illustrates content on the display screen 510 displayed in the back direction after left/right screen switching of the electronic device of FIG. 5A, while a call is received.

The present invention reverses the left/right directions of displayed content when the electronic device has been turned over from the front side to the back side or from the back side to the front side so that content displayed in the front direction and content displayed in the back direction are not reversely displayed.

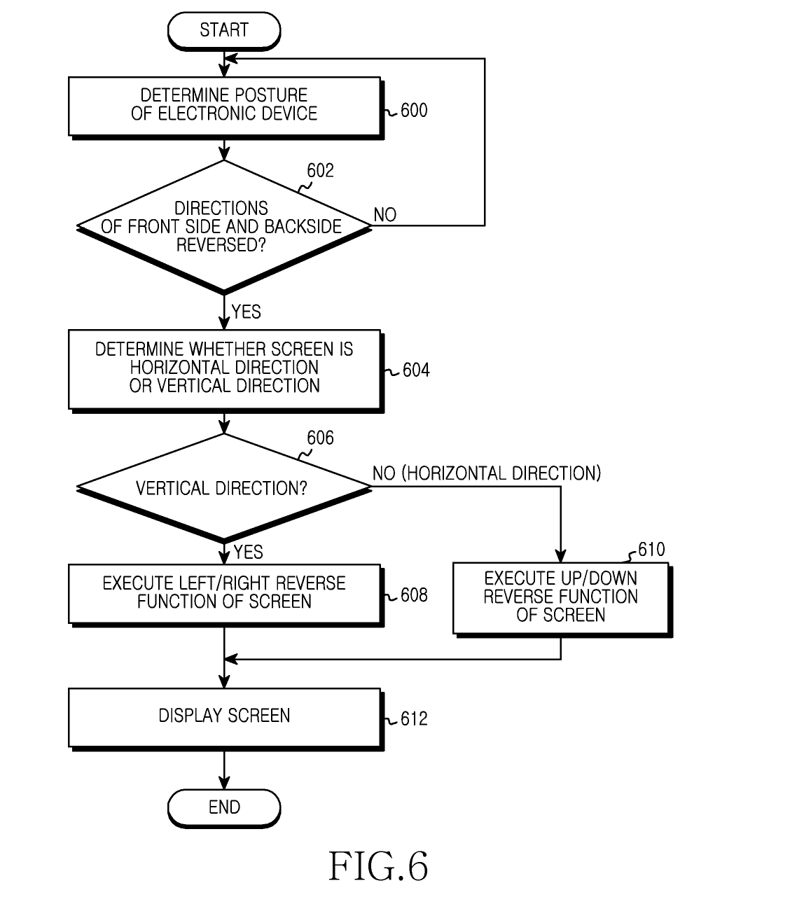

FIG. 6 is a flowchart illustrating a method for switching a screen of an electronic device according to an embodiment of the present invention.

Referring to FIG. 6, the electronic device determines the posture of the electronic device using a camera or a sensor (such as a gyro sensor, an acceleration sensor, and a proximity sensor) in step 600. For example, the electronic device may determine whether the front side/backside is facing the user, and determines the front direction/back direction information of the electronic device by using proximity detected from a sensor, acceleration and an angular velocity (or rotation speed) or detecting a face from an image obtained from a front camera or a backside camera, or comparing illuminance values measured by the front camera and the backside camera.

After that, in step 602, when the directions of the front side and the backside of the electronic device are reversed, that is, when the electronic device is rotated and reversed (or turned over), the electronic device proceeds to step 604 to determine whether the screen of the electronic device is in a horizontal direction or in a vertical direction.

After that, when the screen of the electronic device is in the vertical direction in step 606, the electronic device executes a left/right reverse function of the screen in step 608. When the screen of the electronic device is in the horizontal direction in step 606, the electronic device executes an up/down reverse function.

After that, in step 612, the electronic device displays the up/down reversed or left/right reversed screen.

After that, the electronic device ends the procedure of the present invention.

Depending on implementation, the up/down reversed or left/right reversed screen function may be executed when the directions of the front side and the backside are reversed regardless of whether the screen of the electronic device is in the horizontal direction or in the vertical direction.

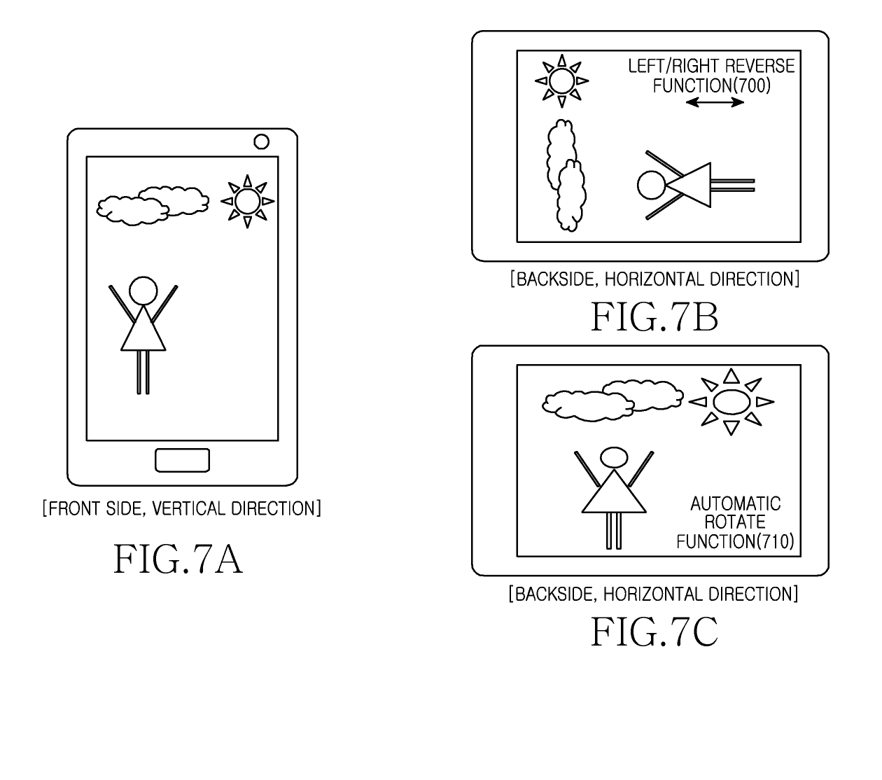

FIGS. 7A, 7B and 7C illustrate before and after screen switching views when directions of a front side and a backside of an electronic device having a transparent display are reversed, and the electronic device is changed from a horizontal direction to a vertical direction according to another embodiment of the present invention.

FIG. 7A illustrates a screen displayed in the front direction with the front side and the backside of the electronic device being open in the vertical direction.

FIG. 7B illustrates a screen 700 left/right reversely displayed when the electronic device is turned over and reversed from the front direction to the back direction and the screen is rotated from the vertical direction to the horizontal direction from the state of FIG. 7A.

FIG. 7C illustrates a screen 710 displayed when the electronic device is turned over and reversed from the front direction to the back direction and the screen is rotated from the vertical direction to the horizontal direction from the state of FIG. 7B, and then the screen is reversed left/right and then the screen is rotated clockwise.

That is, when the electronic device is reversed from the front direction to the back direction and the screen is rotated from the vertical direction to the horizontal direction, the screen is reversed left/right and after that, the screen is rotated clockwise, so that the screen is displayed normally to a user.

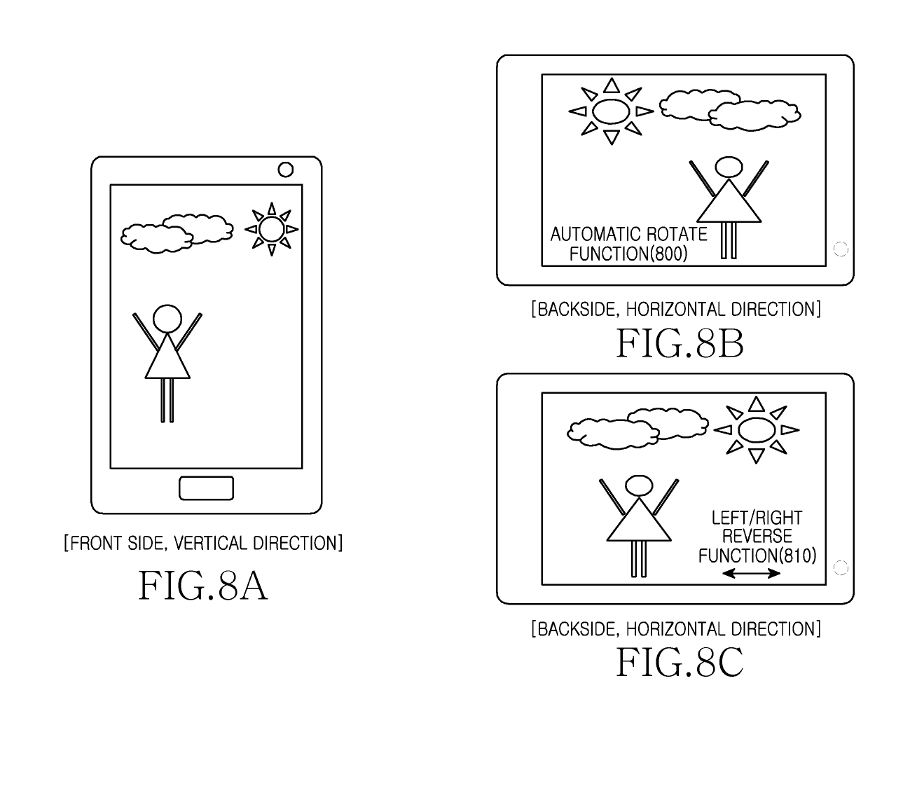

FIGS. 8A, 8B and 8C illustrate before and after screen switching views when directions of a front side and a backside of an electronic device having a transparent display are reversed, and the electronic device is changed from a horizontal direction to a vertical direction according to still another embodiment of the present invention.

FIG. 8A illustrates a screen displayed in the front direction with the front side and the backside of the electronic device being open in the vertical direction.

FIG. 8B illustrates a screen 800 rotated clockwise and displayed when the electronic device is turned over and reversed from the front direction to the back direction and the screen is rotated from the vertical direction to the horizontal direction from the state of FIG. 8A.

FIG. 8C illustrates a screen 810 displayed when the electronic device is reversed from the front direction to the back direction and the screen is rotated from the vertical direction to the horizontal direction from the state of FIG. 8B, and then the screen 800 is rotated clockwise and then reversed left/right to display screen 810.

That is, when the electronic device is reversed from the front direction to the back direction and the screen is rotated from the vertical direction to the horizontal direction, the screen is rotated clockwise and after that, the screen is reversed left/right, so that the screen is displayed normally to a user.

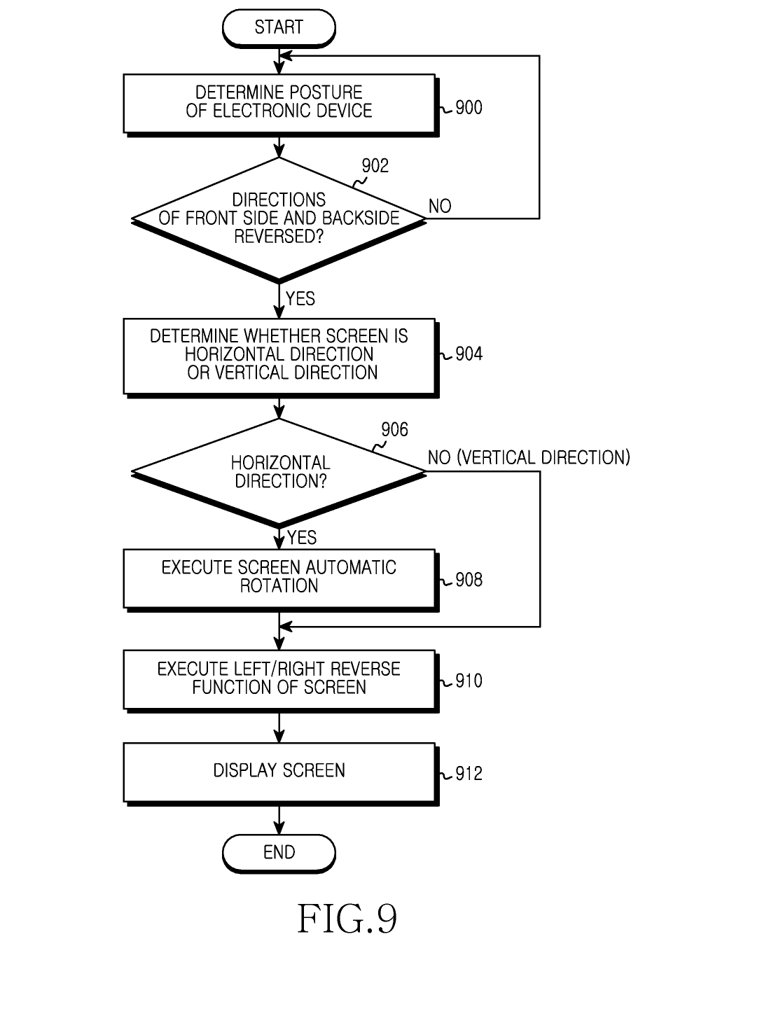

FIG. 9 is a flowchart illustrating a method for switching a screen of an electronic device according to an embodiment of the present invention.

Referring to FIG. 9, the electronic device determines the posture of the electronic device using a camera or a sensor (such as a gyro sensor, an acceleration sensor, and a proximity sensor) in step 900. For example, the electronic device may determine whether the front side/backside is facing the user, and determines the front direction/back direction information of the electronic device by using proximity detected from a sensor, acceleration and an angular velocity (or rotation speed) or detecting a face from an image obtained from a front camera or a backside camera, or comparing illuminance values measured by the front camera and the backside camera.

After that, in step 902, when the directions of the front side and the backside of the electronic device are reversed, that is, when the electronic device is rotated and reversed (or turned over), the electronic device proceeds to step 904 to determine whether the screen of the electronic device is in a horizontal direction or in a vertical direction.

After that, in step 906, when the screen of the electronic device is in the horizontal direction, the electronic device rotates the screen automatically to output the screen in the horizontal direction in step 908.

In contrast, in step 906, when the screen of the electronic device is in the vertical direction, the electronic device proceeds to step 910, where the electronic device executes a screen left/right reverse function.

After that, in step 912, the electronic device rotates the screen clockwise or counterclockwise and reverses the left/right of the screen and displays the same.

After that, the electronic device ends the procedure of the present invention.

Although not shown, when a screen is initially output in the horizontal direction in FIG. 9, when the electronic device is rotated in the vertical direction, automatic rotation may be executed.

Also, depending on implementation, when the electronic device is reversed from the front direction to the back direction and the screen is rotated from the vertical direction to the horizontal direction, the screen is reversed left and right and after that, the automatic rotation function may be executed.

Depending on implementation, when the electronic device is reversely displayed from the front direction to the back direction, a popup window asking whether to reverse the screen left and right may be displayed, or the left/right of the screen may be automatically reversed and displayed without displaying the popup window.

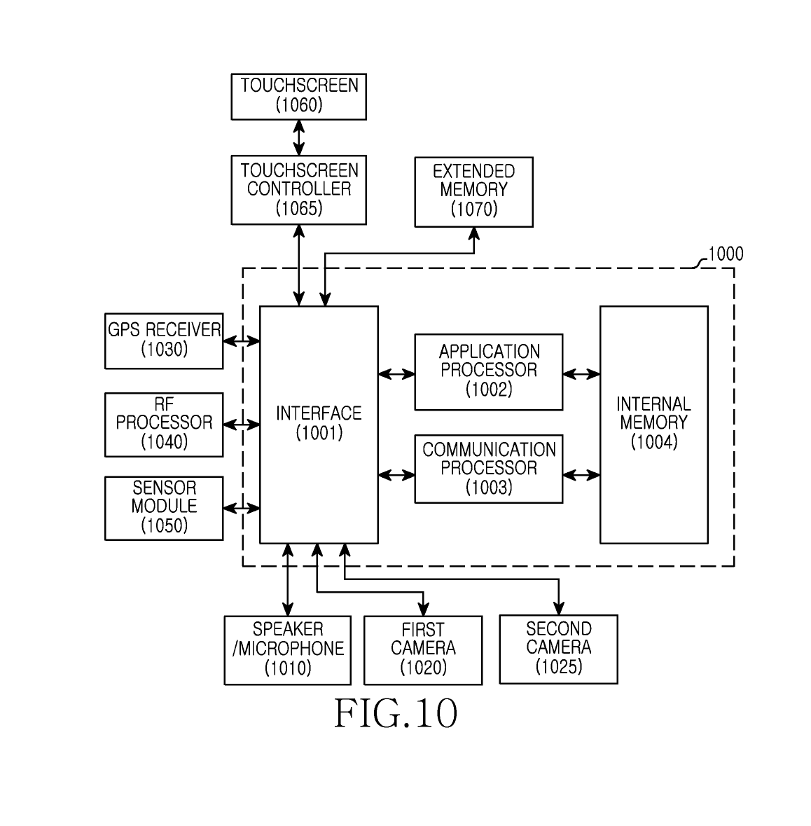

FIG. 10 is a block diagram illustrating an inner construction of an electronic device according to an embodiment of the present invention.

Here, in an embodiment of the present invention, the electronic device may be a portable electronic device and may be a device such as a portable terminal, a mobile terminal, a mobile pad, a media player, a tablet computer, a handheld computer, or a Personal Digital Assistant (PDA). Also, the electronic device may be an arbitrary portable electronic device including a device combining two or more functions among these devices.

Referring to FIG. 10, the electronic device includes a controller 1000, a speaker/microphone 1010, a first camera 1020, a second camera 1025, a GPS receiver 1030, an RF processor 1040, a sensor module 1050, a touchscreen 1060, a touchscreen controller 1065, and an extended memory 1070.

The controller 1000 includes an interface 1001, one or more processors 1002 and 1003, and an internal memory 1004. The entire controller 1000 may be called a processor. The interface 1001, the application processor 1002, the communication processor 1003, and the internal memory 1004 may be separate elements or may be integrated in one or more integrated circuits.

The application processor 1002 executes various software programs to perform various functions for the electronic device, and the communication processor 1003 performs processes and controls voice communication and data communication. Also, in addition to this general function, the processors 1002 and 1003 execute a specific software module (an instruction set) stored in the extended memory 1070 or the internal memory 1004 to perform various specific functions corresponding to the module. That is, the processors 1002 and 1003 control screen switching in cooperation with software modules stored in the extended memory 1070 or the internal memory 1004.

For example, according to an embodiment of the present invention, the application processor 1002 determines the posture of the electronic device using the first camera 1020 or the second camera 1025 or the sensor module 1050, when the directions of the front side and the backside are reversed, that is, when the electronic device is turned over, or rotated and reversed, the application processor 1002 determines whether the screen of the electronic device is in the horizontal direction or in the vertical direction. When the screen of the electronic device is in the vertical direction, the application processor 1002 executes a left/right reverse function of the screen. When the screen of the electronic device is in the horizontal direction, the application processor 1002 executes an up/down reverse function of the screen to display an up/down reversed screen or a left/right reversed screen.

According to another embodiment of the present invention, the application processor 1002 determines the posture of the electronic device using the first camera 1020 or the second camera 1025 or the sensor module 1050, when the directions of the front side and the backside are reversed, that is, when the electronic device is turned over, or rotated and reversed, the application processor 1002 determines whether the screen of the electronic device is in the horizontal direction or in the vertical direction. When the screen of the electronic device is in the horizontal direction, the application processor 1002 automatically rotates the screen, executes a screen left/right reverse function, and displays the screen.

Depending on implementation, when the screen is initially output in the horizontal direction, and when the electronic device is rotated in the vertical direction, the application processor 1002 executes an automatic rotation function.

Depending on implementation, when the electronic device is reversed from the front direction to the back direction and the screen is rotated from the vertical direction to the horizontal direction, the application processor 1002 reverses the left and right of the screen and after that, perform the automatic rotation function.

Meanwhile, the application processor 1002 may determine the posture of the electronic device by detecting a user's face or comparing illuminance values via the first camera 1020 or the second camera 1025. Depending on implementation, the application processor 1002 determines the posture of the electronic device using proximity detected from a proximity sensor, acceleration and an angular velocity (or rotation speed) detected by an acceleration sensor, or a gyro sensor.

The interface 1001 connects to the touchscreen controller 1065 and the extended memory 1070 of the electronic device.

The sensor module 1050 is coupled to the interface 1001 to enable various functions. For example, a movement sensor and a light sensor may be coupled to the interface 1001 to enable detection of the posture of the electronic device and detection of light from the outside, respectively. Other sensors such as a position measurement system, a temperature sensor, or a living body sensor may be connected to the interface 1001 to perform related functions.

The first camera 1020 and the second camera 1025 may be coupled to the sensor module 1050 via the interface 1001. More specifically, the first camera 1020 is positioned in the backside of the electronic device, and the second camera 1025 is positioned in the front side of the electronic device. Also, the first and second cameras 1020 and 1025 may include an optical portion, an image sensor, and a signal processing portion (not shown), etc.

The RF processor 1040 performs a communication function. For example, the RF processor 1040 converts an RF signal into a baseband signal under control of the communication processor 1003 and provides the same to the communication processor 1003, or converts a baseband signal from the communication processor 1003 into an RF signal and transmits the same. Here, the communication processor 1003 processes a baseband signal according to various communication schemes. For example, though not limited thereto, the communication schemes may include Global System for Mobile Communication (GSM) communication scheme, an Enhanced Data GSM Environment (EDGE) communication scheme, a Code Division Multiple Access (CDMA) communication scheme, a Wideband (W)-CDMA communication scheme, a Long Term Evolution (LTE) communication scheme, an Orthogonal Frequency Division Multiple Access (OFDMA) communication scheme, a Wireless Fidelity (Wi-Fi) communication scheme, a WiMax communication scheme and/or a Bluetooth communication scheme.

The speaker/microphone 1010 is used for voice recognition, voice duplication, digital recording, and input/output of an audio stream such as a telephone function. That is, the speaker/microphone 1010 converts a voice signal to an electric signal, or converts an electric signal to a voice signal.

The touchscreen controller 1065 is coupled to the touchscreen 1060. Though not limited thereto, the touchscreen 1060 and touchscreen controller 1065 detect a contact, movements, or stoppage of these using not only capacitive, resistive, and surface acoustic wave technologies for determining one or more contact points with the touchscreen 1060 but also an arbitrary multi-touch detection technology including other proximity sensor arrangements or other elements.

The touchscreen 1060 provides an input/output interface between the electronic device and a user. That is, the touchscreen 1060 transfers a user's touch input to the electronic device. Also, the touchscreen 1060 is a medium showing an output from the electronic device to the user. That is, the touchscreen shows a visual output to the user. This visual output is represented in the form of text, graphics, a video, and a combination of these. In an embodiment of the present invention, the touchscreen 1060 displays images shot by the first camera 1020 and the second camera 1025 and information during shooting.

For the touchscreen 1060, various displays may be used. For example, though not limited thereto, for the touchscreen, a Liquid Crystal Display (LCD), a Light Emitting Diode (LED), a Light Emitting Polymer Display (LPD), an Organic Light Emitting Diode (OLED), an Active Matrix Organic Light Emitting Diode (AMOLED), or a Flexible LED (FLED) may be used.

The touchscreen inputs data using a user's finger, but recently, a pen touch panel (not shown) having a pen-shaped input unit (generally called a ‘touch pen’ or an ‘electronic pen’) as a data auxiliary input means, and selectively inputting data via this pen may be further added.

The GPS receiver 1030 converts a signal received from a satellite to information such as a position, a velocity, a time, etc.

The extended memory 1070 or the internal memory 1004 may include a high speed random access memory such as one or more magnetic disk storages and/or a non-volatile memory, one or more optical storages and/or flash memories (for example, NAND, NOR).

The extended memory 1070 or the internal memory 1004 stores software. A software element includes an Operating System (OS) software module, a communication software module, a graphics software module, a user interface software module and an MPEG module, a camera software module, one or more application software modules, etc. Also, since a module which is a software element may be expressed as a set of instructions, a module is also expressed as an instruction set. A module is also expressed as a program.

The camera software module includes a camera related software element enabling camera related processes and functions. The application module includes a web browser including a rendering engine, an e-mail, an instant message, word processing, keyboard emulation, an address book, a touch list, a widget, Digital Right Management (DRM), voice recognition, voice duplication, a position determining function, a location based service, etc. The memories 1070 and 1004 may include an additional module (instructions) besides the above-described modules. Alternatively, when needed, a portion of a module (instructions) may not be used.

In relation to the present invention, the application module includes instructions for screen switching (refer to FIGS. 6 and 9).

For example, according to an embodiment of the present invention, the application module includes an instruction for determining the posture of the electronic device using the first camera 1020 or the second camera 1025 or the sensor module 1050, when the directions of the front side and the backside are reversed, that is, when the electronic device is turned over, or rotated and reversed, the application module includes an instruction for determining whether the screen of the electronic device is in the horizontal direction or in the vertical direction. When the screen of the electronic device is in the vertical direction, the application module includes an instruction for executing a left/right reverse function of the screen. When the screen of the electronic device is in the horizontal direction, the application module includes an instruction for executing an up/down reverse function of the screen to display an up/down reversed screen or a left/right reversed screen. In addition, when the screen of the electronic device is in the horizontal direction, the application module includes an instruction for automatically rotating the screen, executing a screen left/right reverse function, and displaying the screen. Further, when the screen is initially output in the horizontal direction, and when the electronic device is rotated in the vertical direction, the application module further includes an instruction for executing an automatic rotation function. Also, when the electronic device is reversed from the front direction to the back direction, and the screen is rotated from the vertical direction to the horizontal direction, the application module further includes an instruction for reversing the left and right sides of the screen and after that, performing the automatic rotation function.

In addition, the application module may determine the posture of the electronic device by detecting a user's face or comparing illuminance values via the first camera 1020 or the second camera 1025. The application module includes an instruction for determining the posture of the electronic device using proximity detected from a proximity sensor, acceleration and an angular velocity (or rotation speed) detected by an acceleration sensor or a gyro sensor.

Also, various functions of the electronic device according to the present invention above mentioned and to be mentioned below may be executed by one or more processors and/or hardware including an Application Specific Integrated Circuit (ASIC) and/or softwares and/or a combination of these.

Although the invention has been shown and described with reference to certain embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method in an electronic device, the method comprising:
detecting a state where a front direction of the electronic device is reversed from a first direction to a second direction, and a back direction of the electronic device is reversed from the second direction to the first direction; and
when a front side and a backside of the electronic device are reversed, displaying a left/right reversed screen or an up/down reversed screen.

2. The method of claim 1, wherein detecting the state where the front direction of the electronic device is reversed from the first direction to the second direction, and the backside of the electronic device is reversed from the second direction to the first direction comprises:
detecting a user's face from images obtained via at least one of a first camera and a second camera, respectively; and
when detecting a face from a previous image obtained from the first camera and not detecting a face from a current image, or detecting a face from the previous image obtained from the first camera and detecting the same face from a current image obtained from the second camera, determining the front side and the backside of the electronic device have been reversed.

3. The method of claim 1, wherein detecting the state where the front direction of the electronic device is reversed from the first direction to the second direction, and the backside of the electronic device is reversed from the second direction to the first direction comprises:
measuring illuminances from a first camera and a second camera, respectively;
comparing a first illuminance value measured by the first camera with a second illuminance value measured by the second camera; and
determining a posture of the electronic device depending on the comparison result.

4. The method of claim 3, wherein determining the posture of the electronic device depending on the comparison result comprises:
when a difference between the first illuminance value and the second illuminance value is greater than or equal to a first threshold, determining the electronic device is disposed with its backside open, and
when the difference between the first illuminance value and the second illuminance value is less than or equal to a second threshold, determining that the electronic device is disposed with its front side open.

5. The method of claim 4, further comprising, when the difference between the first illuminance value and the second illuminance value is a value between the first threshold and the second threshold, determining the electronic device is disposed with both its front side and its backside open.

6. The method of claim 1, wherein when a screen of the electronic device is displayed towards the front direction, the screen is not displayed towards the back direction of the electronic device, and when the screen of the electronic device is displayed towards the back direction, the screen is not displayed towards the front direction of the electronic device.

7. The method of claim 1, wherein when a first screen is displayed towards the front direction of the electronic device, the first screen is reversed left and right, or up and down, and displayed towards a back direction of the electronic device.

8. The method of claim 1, further comprising, when the electronic is rotated from a vertical direction to a horizontal direction, or the electronic is rotated from the horizontal direction to the vertical direction, rotating the screen.

9. An electronic device comprising:
one or more processors;
a memory; and
one or more programs stored in the memory and configured for execution by the one or more processors,
wherein the program comprises instructions for detecting a state where a front direction of the electronic device is reversed from a first direction to a second direction, and a back direction of the electronic device is reversed from the second direction to the first direction, and
when a front side and a backside of the electronic device are reversed, displaying a left/right reversed screen or an up/down reversed screen.

10. The electronic device of claim 9, wherein the program further comprises instructions for detecting a user's face from images obtained via at least one of a first camera and a second camera, respectively, and
when detecting a face from a previous image obtained from the first camera and not detecting a face from a current image, or detecting a face from the previous image obtained from the first camera and detecting the same face from a current image obtained from the second camera, determining the front side and the backside of the electronic device have been reversed.

11. The electronic device of claim 9, wherein the program further comprises instructions for measuring illuminances from a first camera and a second camera, respectively,
comparing a first illuminance value measured by the first camera with a second illuminance value measured by the second camera, and
determining a posture of the electronic device depending on the comparison result.

12. The electronic device of claim 11, wherein the program further comprises instructions for,
when a difference between the first illuminance value and the second illuminance value is greater than or equal to a first threshold, determining the electronic device is disposed with its backside open, and
when the difference between the first illuminance value and the second illuminance value is less than or equal to a second threshold, determining that the electronic device is disposed with its front side open.

13. The electronic device of claim 12, wherein the program further comprises an instruction for,
when the difference between the first illuminance value and the second illuminance value is a value between the first threshold and the second threshold, determining the electronic device is disposed with both its front side and its backside open.

14. The electronic device of claim 9, wherein when a screen of the electronic device is displayed towards the front direction, the screen is not displayed towards the back direction of the electronic device, and
when the screen of the electronic device is displayed towards the back direction, the screen is not displayed towards the front direction of the electronic device.

15. The electronic device of claim 9, wherein when a first screen is displayed towards the front direction of the electronic device, the first screen is reversed left and right, or up and down, and displayed towards the back direction of the electronic device.

16. The electronic device of claim 9, wherein the program further comprises an instruction for, when the electronic is rotated from a vertical direction to a horizontal direction, or the electronic is rotated from the horizontal direction to the vertical direction, rotating the screen.

17. A method in an electronic device, the method comprising:
detecting a user's face from images obtained via at least one of a first camera and a second camera of the electronic device, respectively;
detecting a state where a front direction of the electronic device is reversed from a first direction to a second direction, and a back direction of the electronic device is reversed from the second direction to the first direction based on the face detection result; and
when a front side and a backside of the electronic device are reversed, displaying a left/right reversed screen or an up/down reversed screen.

18. The method of claim 17, wherein detecting the state where the front direction of the electronic device is reversed from the first direction to the second direction, and the backside of the electronic device is reversed from the second direction to the first direction comprises:
when detecting a face from a previous image obtained from the first camera and not detecting a face from a current image, or detecting a face from the previous image obtained from the first camera and detecting the same face from a current image obtained from the second camera, determining the front side and the backside of the electronic device have been reversed.

19. The method of claim 17, further comprising, when the electronic device is rotated from a vertical direction to a horizontal direction, or when the electronic device is rotated from the horizontal direction to the vertical direction, rotating the screen.

20. The method of claim 17, wherein when a first screen is displayed in the front direction of the electronic device, left/right or up/down of the first screen are reversely displayed in the back direction of the electronic device.
